(19) United States
(12) Patent Application Publication
(10) Pub. No.: US 2020/0378425 A1
(43) Pub. Date: Dec. 3, 2020

(54) TAMPER-RESISTANT HOLE COVERING SYSTEMS AND RELATED METHODS

(71) Applicant: Enginuity Power Systems,Inc., Alexandria, VA (US)

(72) Inventor: Steven Spurr, Brownstown, MI (US)

(73) Assignee: Enginuity Power Systems, Inc., Alexandria, VA (US)

(21) Appl. No.: 16/885,779

(22) Filed: May 28, 2020

Related U.S. Application Data
(60) Provisional application No. 62/921,076, filed on May 30, 2019.

(51) Int. Cl. F16B 12/30; F16B 43/00

(52) U.S. Cl. CPC F16B 12/30; F16B 43/001

(57) ABSTRACT

Tamper-resistant, hole covering systems are provided. An exemplary system may include tamper-resistant coverings on the sides of a hole of an article to cover the hole and a tamper-resistant fastener that passes through the hole and securely connects the two coverings.

### RELATED APPLICATION

The present application claims priority to U.S. Provisional Application No. 62/921,076 filed May 30, 2019 (the “'076 Application”). The present application incorporates by reference herein the entirety of the disclosure of the '076 Application.

### INTRODUCTION

This section introduces aspects that may be helpful to facilitate a better understanding of the described invention(s). Accordingly, the statements in this section are to be read in this light and are not to be understood as admissions about what is, or what is not, in the prior art.

There is a need to provide a system or device for use in repairing, covering or filling (collectively “covering”) holes in articles, such as furniture (e.g., flat metal bed frames). Further, when an article is used in a correctional facility (e.g., prison, jail) there is a need for the system or device to be tamper-resistant and tamper-proof (collectively “tamper-resistant”).

Accordingly, it is desirable to provide tamper-resistant systems, devices and related methods for covering holes in articles.

### BRIEF DESCRIPTION OF DRAWINGS

FIGS. 1A and 1B depict an exemplary system according to an embodiment of the invention.

FIGS. 2A and 2B depict an exemplary fastener component that may be used as a part of an exemplary system according to an embodiment of the invention.

FIGS. 3A to 3D depict different views of a first cover component that may be used as a part of an exemplary system according to an embodiment of the invention.

FIGS. 4A and 4B depict different views of a second cover component according to an embodiment of the invention.

FIGS. 4C to 4E depict different views of another second cover component according to an embodiment of the invention.

### SUMMARY

Various embodiments of tamper-resistant, hole covering systems are described herein. For example, one such system may comprise: a first covering (e.g., composed of a stainless steel) comprising a through passageway, a second covering (e.g., composed of a stainless steel) comprising a non-through passageway, and a fastener (e.g., composed of an 18-8 stainless steel), where the fastener is operable to be inserted through the through passageway, through a hole in an article (e.g., metal bed, other articles of furniture, or other metal articles composed of metal that surrounds a hole) into the non-through passageway to connect the first and second coverings so that the coverings cover both sides of the hole in the article.

In an embodiment, the fastener may comprise a first threaded portion and the non-through passageway may comprise a second threaded portion that corresponds to the first threaded portion to allow the fastener to be threadably inserted and secured in the non-through passageway.

To increase the tamper-resistance of the system, the fastener may comprise an elongated head, where the head further comprises a non-regular indentation or surface.

To further increase the rust-resistance of the coverings, a surface or surfaces of the first or second coverings may comprise a phosphate coating or layer, for example.

In embodiments, one or more such systems described herein may also comprise a material for forming a tamper-resistant bonding layer between at least surfaces of the fastener and a surface of the non-through passageway, among other bonding layers between other components of a system. The material may comprise a thread-locking fluid or paste when first applied to a fastener or another component of an inventive system.

In an alternative tamper-resistant, hole covering system the first covering comprises one or more radially-extending channels, each of the channels configured to allow passage of a liquid (i.e., drainage), and/or the second covering may also comprise one or more radially-extending channels, where similarly each of the channels are configured to allow for passage of a liquid.

In yet another embodiment, a tamper-resistant, hole covering system may comprise: a first covering, a second covering comprising a threaded, non-through passageway, and a threaded fastener integral to the first covering, wherein the threaded fastener is operable to be inserted through a hole of an article and into the threaded, non-through passageway to connect the first and second coverings so that the coverings cover both sides of the hole in the article.

In still another embodiment, a tamper-resistant, hole covering system may comprise: a first covering comprising a through passageway, a second covering comprising a threaded, non-through passageway, and a threaded fastener, the fastener comprising an elongated head, and the head comprises a non-regular indentation or surface, wherein the threaded fastener is operable to be inserted through the through passageway, through a hole in an article and threadably inserted into the non-through passageway to connect the first and second coverings so that the coverings cover both sides of the hole in the article.

Similarly to other embodiments, this embodiment may additionally comprise a material (a thread locking fluid or paste) for forming a tamper-resistant bonding layer between at least surfaces of the fastener and the surface of the non-through passageway.

Further, in this embodiment the first covering may comprise one or more radially-extending channels, where each of the channels may be configured to allow passage of a liquid (i.e., drainage), and the second covering may also comprise one or more radially-extending channels, where again, each of the channels may be configured to allow for passage of a liquid.

Another embodiment of a tamper-resistant, hole covering system combines one or more features of each of the previous embodiments. For example, such a system may comprise: a first covering comprising a through passageway, a second covering comprising a threaded, non-through passageway, a threaded fastener, the fastener comprising an elongated head, and the head comprising a non-regular indentation or surface, and a material for forming a tamper-resistant bonding layer between at least surfaces of the fastener and the surface of the non-through passageway, wherein the threaded fastener is operable to be inserted through the through passageway, through a hole in an article and threadably inserted into the non-through passageway to connect the first and second coverings so that the coverings cover both sides of the hole in the article.

In addition to the systems described above, the present invention also provides corresponding tamper-resistant methods to cover holes in articles that make use of the inventive systems.

### DETAILED DESCRIPTION, WITH EXAMPLES

Exemplary embodiments of tamper-resistant, hole covering systems, devices and related methods are described herein and are shown by way of example in the drawings. Throughout the following description and drawings, like reference numbers/characters refer to like elements.

It should be understood that although specific embodiments are discussed herein, the scope of the disclosure is not limited to such embodiments. On the contrary, it should be understood that the embodiments discussed herein are for illustrative purposes, and that modified and alternative embodiments that otherwise fall within the scope of the disclosure herein are contemplated.

As used herein, the words “comprising”, and any form thereof such as “comprise” and “comprises”; “having”, and any form thereof such as “have” and “has”; “including”, and any form thereof such as “includes” and “include”; and “containing” and any form thereof such as “contains” and “contain” are inclusive or open-ended and do not exclude additional, unrecited elements or process steps.

As used herein, the term “a” or “an” may mean “one”, but is also consistent with the meaning of “one or more”, “at least one”, and “one or more than one”.

It should also be understood that one or more exemplary embodiments may be described as an installation process or method. Although an installation process/method may be described as sequential, it should be understood that such a process/method may be performed in parallel, concurrently or simultaneously. In addition, the order of each step within a process/method may be re-arranged. An installation process/method may be terminated when completed and may also include additional steps not included in a description of the process/method.

As used herein, the term “and/or” includes any and all combinations or permutations of one or more of the associated listed items.

It should be understood that when used herein, the designations “first”, “second”, “third”, etc., is purely to distinguish one component or element of a system or device or part of a process from another and does not indicate an importance, priority or status unless the context, common sense or recognized knowledge of those skilled in the art indicate otherwise. In fact, in some cases the component or elements of a process could be re-designated (i.e., re-numbered) and it would not affect the scope of the present invention.

As used herein the phrases “top” or “bottom” connote the relative position of an element or component of an inventive system or device with respect to a hole. Depending on the orientation of an inventive system, device or related method with respect to a hole that is to be covered, an element or component may appear to be placed over one side of a hole (e.g., on top of the hole) and/or may appear to be placed on the opposite side of the hole (e.g., on the bottom of the hole). As the reader may recognize, if the hole is re-oriented such that the sides of the hole are reversed, then the phrases “top” and “bottom” may be reversed as well. In any event when both phrases are used in conjunction with the phrase “covering” the combined phrase connotes an element or component of an inventive system or device that substantially covers a hole (except, perhaps for the portion of one side of a hole taken up by a fastener, as described herein).

As used herein the phrases “connection”, “connected to”, or similar phrases means a physical connection between at least two different components of a device or system or means one component of a device or system is subsumed within (and thereby connected to) at least one other component of a device or system. It should be understood that when one component of a device or system is described or depicted as being connected to another component, other components used to facilitate such a connection may not be described or depicted because such components are well known to those skilled in the art (e.g., welds).

Yet further, when one component of a device or system is described or depicted as being connected to another component using “a connection” (or single line) in a figure it should be understood that practically speaking such a connection (line) may comprise (and many times will comprise) more than one physical connection.

It should be noted that the systems, devices, as well as any components, or elements thereof, illustrated in the figures are not necessarily drawn to scale, and need not be representative of an actual shape or size and need not be representative of any actual device. Rather, the systems, devices, components and elements are drawn so as to help explain the features, functions and processes of various exemplary embodiments of the present invention described herein.

Relatedly, to the extent that any of the figures or text included herein depicts or describes dimensions or operating parameters it should be understood that such information is merely exemplary and is provided to enable one skilled in the art to make and use an exemplary embodiment of the invention without departing from the scope of the invention.

As used herein, the terms “embodiment” or “exemplary” refer to an example of the present invention.

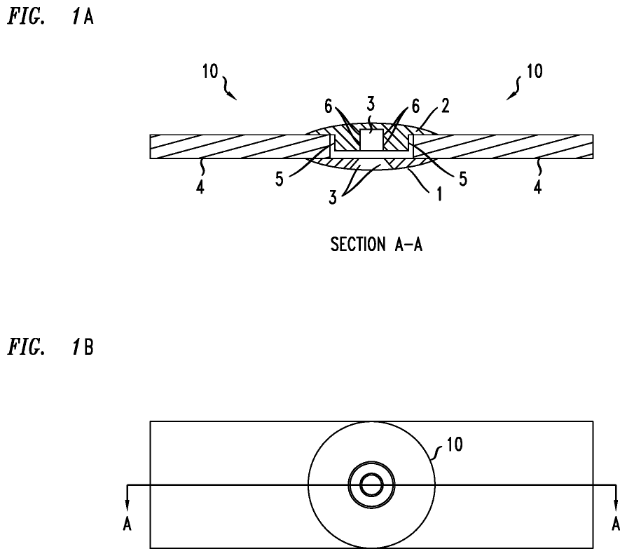

FIGS. 1A and 1B depict views of an exemplary system 10 according to an embodiment of the invention. In particular, the view in FIG. 1 represents a sectional view along section “A-A” as shown in FIG. 1B.

Exemplary system 10 may comprise, for example, a first covering 1, a second covering 2 and a fastener component 3. The first and second coverings 1, 2 along with the fastener 3 function to cover holes in metal articles, such as the metal surface 4 of a bed as well as other metal articles that include holes. As described further herein, properly installed the system 10 may be tamper-resistant.

In an embodiment, the first covering 1 may comprise a stainless steel cover that functions to be rigid enough to withstand forces typically applied to the article 4 and is rust-resistant. In an embodiment, the first covering 1 may comprise a phosphate coating on one, more than one or on substantially all of the surfaces of the covering 1 that functions to add additional rust-resistance or prevention. Similarly, in an embodiment, the second covering 2 may comprise a stainless steel plate that functions to be rigid enough to withstand forces typically applied to the article 4 and is rust-resistant. In embodiments, the second coverings described herein may further comprise a phosphate coating on one. More than one or substantially all of the surfaces of the covering that functions to add additional rust-resistance or prevention.

As shown, the system 10 has been installed so as to cover both sides of a hole 5. In an embodiment, the hole 5 may be one of many holes in a flat metal bed 4 that is used in a correctional facility, for example. Such holes are formed in a bed to allow for drainage when, for example, overhead water sprinklers are opened and water or another liquid falls down onto the surface of the flat bed 4. To allow the water to drain off the flat bed, one or more drainage holes, like hole 5, are made in the bed 4. The drainage holes may, however, be misused by an occupant of a prison cell. Thus, a need to cover some or all of the holes.

It should be noted, however, that the inventive systems (e.g., system 10) is not limited to just covering the holes in a metal prison bed. Holes in other types of furniture may also be covered using the inventive systems described herein and equivalents of such inventive systems claimed herein. Yet further, the inventive systems may be used to cover a hole in an article where the hole is surrounded by metal where typically the hole would be covered using a nut and bolt, or by welding or brazing metal over the hole.

While the fastener 3 is depicted as a separate part of the system 10, in an alternative embodiment it may be an integral part of the first or second covering 1, 2 (e.g., one end of the fastener may be integral with a covering 1,2).

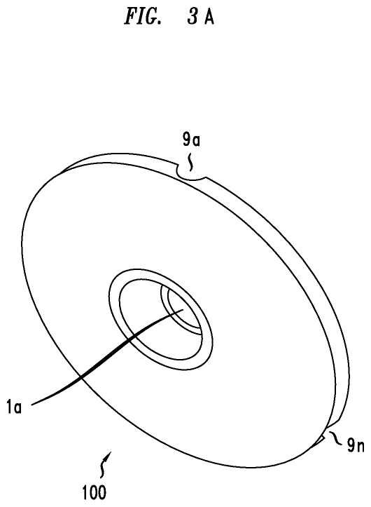

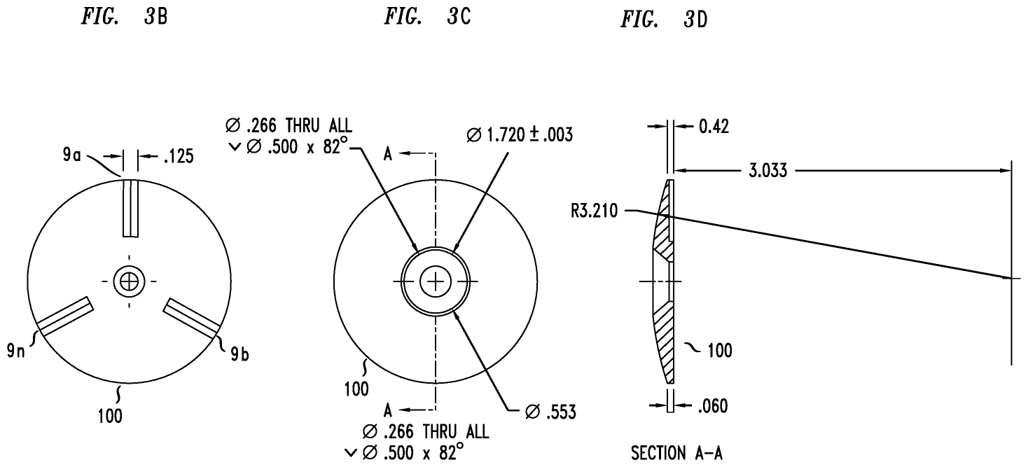

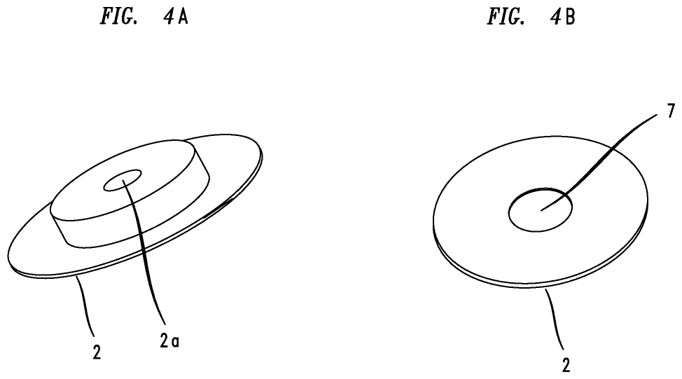

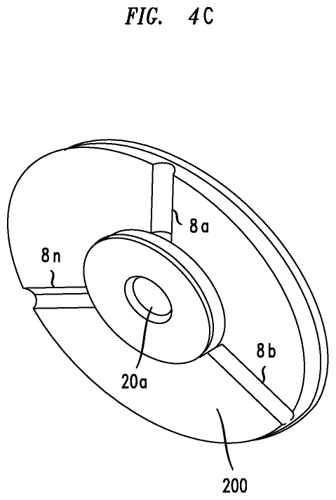

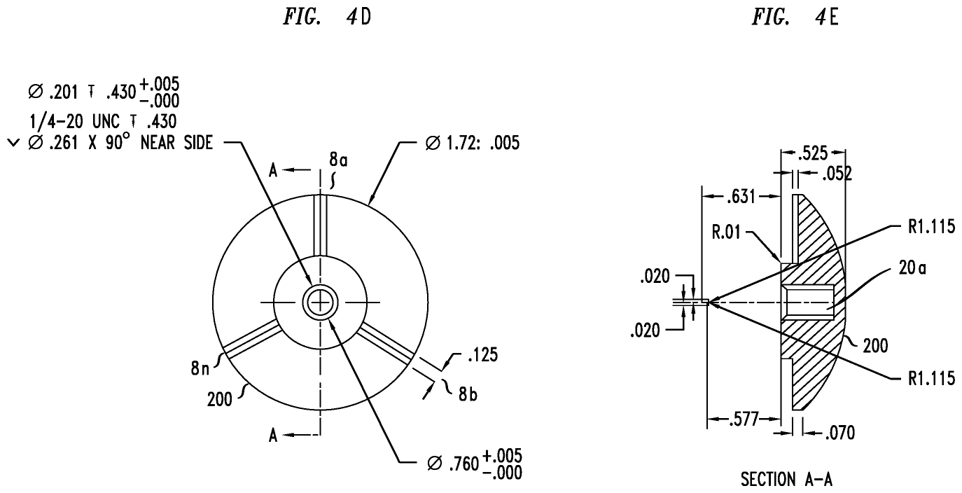

In an exemplary embodiment, either covering 1, 2 may be placed on top or bottom of the hole 5 in article 4. In FIG. 1A the second covering 2 is shown covering the top of the hole 5 while the first covering 1 is shown covering the bottom of the hole 5. In an embodiment, once the two coverings 1, 2 are in position over the opposing sides of the hole 5, the fastener 3 may be operable to be inserted (i.e., moved) through a through passageway 1a in the first covering (see, for example, passageway 1a in first covering 100 in FIG. 3A), then through the hole 5 and into a non-through passageway 2a in second covering (see, for example, passageway 2a in FIG. 4A or 20a in FIGS. 4C and 4E). Accordingly, the fastener 3 functions to securely connect the two coverings 1, 2 so that the coverings 1, 2 cover both sides of the hole 5 in the article 4. By “through passageway” is meant an enclosed passageway that has openings on its each of a covering, while a “non-through passageway” means an enclosed passageway that only has one opening on one side of a covering,

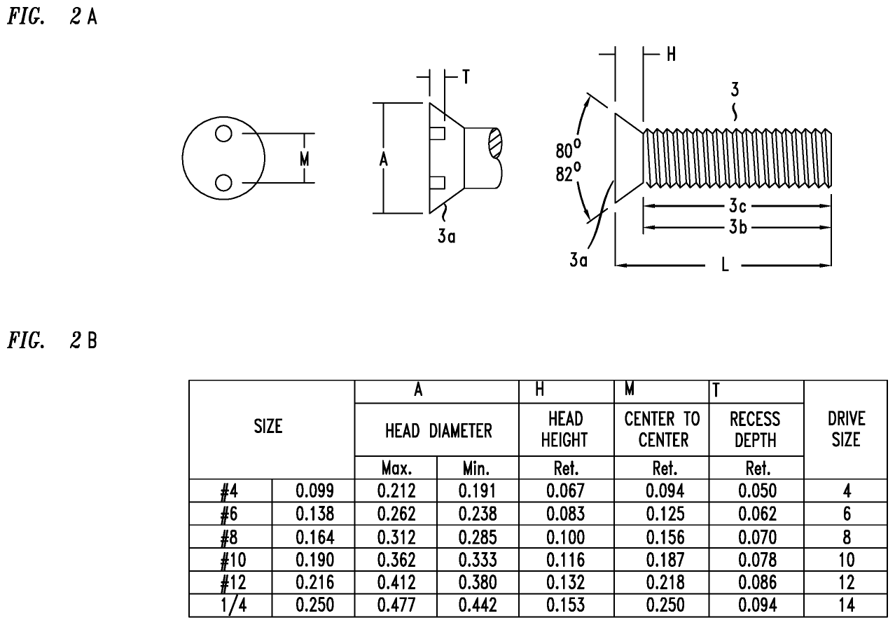

Referring now to FIG. 2A there is depicted an exemplary fastener 3. As shown the fastener may comprise an elongated head 3a and threaded portion 3b (for clarity “first threaded portion”), where in one embodiment the first threaded portion substantially covers all of a lengthwise section 3c of fastener 3. It should be understood that this embodiment illustrates the fastener 3 as a separate component of an inventive system. In alternative embodiments, when an inventive fastener is integral with a covering 1, 2 (e.g., by welding, or casting) the head 3a may not be needed.

It should be noted that the first threaded portion 3b may not cover all of section 3c, but, instead just a portion of section 3c needed to securely connect the two coverings together. When an inventive fastener includes a threaded portion it may be referred to as a “treaded fastener”.

Continuing, in an embodiment the threaded fastener 3 may be installed or inserted through the through passageway 1a in first covering 1, through both sides of the hole 5 and into the non-through passageway 2a in a second covering 2. In this embodiment, the non-through passageway 2a may also comprise a threaded portion (for clarity, “second threaded portion”; not shown in figures) that is configured to correspond to the length and thread size and pattern of the first threaded portion 3b of fastener 3 to allow the fastener 3 to be threadably inserted and secured in the threaded, non-through passageway 2a in order to securely connect the fastener 3 and first covering 1 to the covering 2 so that the coverings 1, 2 cover both sides of the hole 5 in the article 4. On the opposite end of the fastener 3, the head 3a may be screwed or rotated such that the first threaded portion 3b mates with the second threaded portion of the passageway 2a.

In an embodiment when the fastener 3 is a separate component, the head 3a may comprise an elongated head that comprises a non-regular indentation or surface for increasing the tamper-resistance of the system 10 (not shown in figures) (e.g., a keyed spanner screw head). Accordingly, the head may be configured such that the fastener 3 cannot be rotatably removed or turned using a typical flat-head or Phillips-head screwdriver. Instead, a customized tool that has a corresponding head whose surface or surfaces mates to the non-regular surface of the head 3a may be used to rotate or turn the fastener 3 (e.g., a keyed spanner screw-driver or tool). The use of head 3a that is shaped as a non-regular indentation or surface functions to increase the tamper-resistance of the system 10 once installed to cover a hole.

Where the fastener is integral to either covering (welded, cast) once a threaded portion of a fastener (e.g., portion 3b) begins to be inserted into the threaded portion of a non-through passageway of one of the coverings, the integral covering and fastener may be rotated to threadably insert the fastener into the threaded portion of the non-through passageway in order to securely connect the two coverings. For example, when a threaded fastener is integral to a first covering the fastener may be operable to be inserted through a hole in an article and then into a threaded portion of a non-through passageway of a second covering to securely connect the first and second coverings so that the coverings cover both sides of the hole in the article.

Before the fastener 3 is inserted or moved through and/or into the passageways 1a,2a in the coverings 1, 2 and hole 5, an anaerobic material may be applied to surfaces of the fastener 3 (e.g., portion 3b), and/or to the inside surfaces of coverings 1,2 (including passageways 1a,2a) and/or hole 5. Once applied, the material eventually functions to form a tamper-resistant bonding layer between at least surfaces of the fastener 3 (e.g., portion 3b) and the inside surface of the non-through passageway 2a. Further, another layer or the same layer may also form between the fastener 3 (e.g., portion 3b) and the inside surfaces of the coverings 1, 2, passageway 1a and surfaces of the hole 5 once the fastener 3 (e.g., portion 3b) is moved into the passageway 2a and the material dries due to a lack of oxygen. In an embodiment the material may comprise a thread locking fluid or paste as it is initially applied to components of system 10 and before the material dries or solidifies.

Accordingly, inventive systems provided by the present invention, such as system 10, that include the combination of non-regular shaped heads (e.g., head 3a) or no head at all in combination with the bonding material are substantially tamper-resistant.

FIG. 2B depicts exemplary dimensions of the fastener 3, including exemplary dimensions of the head 3a and portions 3b, 3c. In an embodiment, an inventive fastener 3 may comprise a stainless steel composition (e.g., 18-8 stainless steel).

Referring now to FIGS. 3A to 3D there are depicted exemplary views of an alternative first covering 100. Covering 100 is configured to complete the same functions of covering 1 described herein (e.g., to cover a hole). In addition, first covering 100 may comprise one or more radially-extending grooves or channels 9a to 9n (collectively “channels”, where “n” connotes a last channel), each of which functions to at least allow for the drainage or passage of liquid, such as water, that may seep through the hole 5. In an embodiment, water that may contact the article 4 (e.g., bed) may seep through the hole 5 and be directed away from the hole 5, system 10 and bed 4 by the channels 9a to 9n. While 2 or 3 channels 9a to 9n are shown in FIGS. 3A to 3D, it should be understood that fewer channels (0, 1) or more channels may be included in a first covering.

Referring now to FIGS. 4A and 4B there are depicted exemplary views of various embodiments of a second covering.

In FIG. 4A, the second covering 2 is shown with the passageway 2a being positioned centrally, while in FIG. 4B the second covering is shown inverted with a substantially flat portion 7, having a center in the same geometric plane as the center of the passageway 2a, that has been worked (e.g., sanded) to remove any sharp corners or edges. In embodiments the passageway 2a functions to both receive the fastener 3 and as a “blind hole” to hide the fastener 3 from view so that the fastener 3 cannot be tampered with. In addition, because the passageway 2a is a non-through passageway (i.e., it does not go all the way through covering 2) it prevents air (e.g., oxygen) from contacting material 6, allowing the material to harden and, thereafter, forming a bond (e.g., bonding surfaces, bonding layer) between the fastener 3 and coverings 1, 2.

Referring now to FIGS. 4C to 4E, an alternative embodiment of a second covering 200 is depicted. In an embodiment, covering 200 may be configured to complete the same functions of covering 2 described herein (e.g., to cover a hole). In addition, second covering 200 may comprise one or more radially-extending grooves or channels 8a to 8n (collectively “channels”, where “n” connotes a last channel), each of which functions to at least allow for the drainage or passage of liquid, such as water, that may seep through the hole 5. In an embodiment, water that may contact the article 4 (e.g., bed) may seep through the hole 5 and be directed away from the hole 5, system 10 and bed 4 by the channels 8a to 8n. While three channels 8a to 8n are shown in FIGS. 4C to 4E it should be understood that fewer channels (0, 1 or 2) or more channels may be included in a second covering.

As noted previously, the dimensions depicted in all of the figures is merely exemplary. For example, the dimensions of each of the components of an inventive system may be tailored to the dimensions (e.g., diameter and length) of a particular hole, for example.

From the foregoing description, one skilled in the art can easily ascertain the essential characteristics of the invention. Further, it should be understood that the foregoing description only describes a few of the many possible embodiments that fall within the scope of the inventions. Accordingly, those skilled in the art may make numerous changes and modifications to the embodiments disclosed herein without departing from the general spirit of the invention, the scope of which is best defined by the claims that follow.

1. A tamper-resistant, hole covering system comprising:
a first covering comprising a through passageway,
a second covering comprising a non-through passageway,
and a fastener,
wherein the fastener is operable to be inserted through the through passageway, through a hole in an article and into the non-through passageway to connect the first and second coverings so that the coverings cover both sides of the hole in the article.

2. The system as in claim 1 wherein the article comprises a metal bed.

3. The system as in claim 1 wherein the article comprises an article of furniture.

4. The system as in claim 1 wherein the article is composed of metal surrounding the hole.

5. The system as in claim 1 wherein the fastener comprises a first threaded portion and the non-through passageway comprises a second threaded portion that corresponds to the first threaded portion to allow the fastener to be threadably inserted and secured in the threaded, non-through passageway.

6. The system as in claim 1 wherein the fastener comprises an elongated head, and the head comprises a non-regular indentation or surface for increasing the tamper-resistance of the system.

7. The system as in claim 1 wherein the first and second coverings comprise a stainless steel.

8. The system as in claim 1 wherein the fastener comprises a stainless steel.

9. The system as in claim 1 wherein a surface of the first or second coverings comprises a phosphate coating or layer.

10. The system as in claim 1 further comprising a material for forming a tamper-resistant bonding layer between at least surfaces of the fastener and a surface of the non-through passageway.

11. The system as in claim 10 wherein the material comprises a thread-locking fluid or paste.

12. The system as in claim 1 wherein the first covering comprises one or more radially-extending channels, each of the channels configured to allow passage of a liquid.

13. The system as in claim 1 wherein the second covering comprises one or more radially-extending channels, each of the channels configured to allow for passage of a liquid.

14. A tamper-resistant, hole covering system comprising:
a first covering,
a second covering comprising a threaded, non-through passageway,
and a threaded fastener integral to the first covering, wherein the threaded fastener is operable to be inserted through a hole of an article and into the threaded, non-through passageway to connect the first and second coverings so that the coverings cover both sides of the hole in the article.

15. A tamper-resistant, hole covering system comprising:
a first covering comprising a through passageway,
a second covering comprising a threaded, non-through passageway,
and a threaded fastener, the fastener comprising an elongated head, and the head comprises a non-regular indentation or surface,
wherein the threaded fastener is operable to be inserted through the through passageway, through a hole in an article and threadably inserted into the threaded, non-through passageway to connect the first and second coverings so that the coverings cover both sides of the hole in the article.

16. The system as in claim 15 further comprising a material for forming a tamper-resistant bonding layer between at least surfaces of the fastener and a surface of the non-through passageway.

17. The system as in claim 16 wherein the material comprises a thread-locking fluid or paste.

18. The system as in claim 15 wherein the first covering comprises one or more radially-extending channels, each of the channels configured to allow passage of a liquid.

19. The system as in claim 15 wherein the second covering comprises one or more radially-extending channels, each of the channels configured to allow for passage of a liquid.

20. A tamper-resistant, hole covering system comprising:
a first covering comprising a through passageway,
a second covering comprising a threaded, non-through passageway,
a threaded fastener, the fastener comprising an elongated head, and the head comprises a non-regular indentation or surface, and
a material for forming a tamper-resistant bonding layer between at least surfaces of the fastener and a surface of the non-through passageway,
wherein the threaded fastener is operable to be inserted through the through passageway, through a hole in an article and threadably inserted into the non-through passageway to connect the first and second coverings so that the coverings cover both sides of the hole in the article.
